(19) United States
(12) Patent Application Publication
(10) Pub. No.: US 2007/0269191 A1
(43) Pub. Date: Nov. 22, 2007

(54) Stream data recording method and stream data recording apparatus

(76) Inventors: Kunio Dono, Osaka (JP); Kentaro Hirao, Osaka (JP)

Correspondence Address: MCDERMOTT WILL & EMERY LLP, 600 13TH STREET, NW, WASHINGTON, DC, 20005-3096, US

(21) Appl. No.: 11/802,090

(22) Filed: May 18, 2007

(30) Foreign Application Priority Data
May 18, 2006 (JP) 2006-139028
May 14, 2007 (JP) 2007-128176

(51) Int. Cl. H04N 5/00

(52) U.S. Cl. 386/126

(57) ABSTRACT

A stream data recording apparatus includes a data object generation section for receiving video/audio data and generating from the video/audio data a data object complying with a standard with respect to the recording, a buffer for temporarily accumulating the generated data object by the data object generation section, and an optical recording section for writing the accumulated data object in the buffer to the optical recording medium. In this apparatus, the optical recording section performs initial preparation for data writing to the optical recording medium during generation of the data object by the data object generation section.

### BACKGROUND OF THE INVENTION

The present invention relates to a stream data recording method and a stream data recording apparatus, and more particularly relates to a technique for recording stream data obtained by compression coding video/audio data on an optical recording medium in real time.

In general, a format complying with the DVD video standard is used for data recording on a DVD (Digital Versatile Disc). FIG. 7 is a diagram illustrating a data structure complying with the DVD video standard. In FIG. 7, an inner circumference side of an optical disk is shown on the left hand side and an outer circumference side of the optical disk is shown on the right hand side. In the direction from a most inner circumference of the optical disk toward the outer circumference, a volume-and-file structure zone and a DVD-Video zone are arrayed in this order. The volume-and-file structure zone stores file system information of the optical disk. The DVD-Video zone stores video streams complying with the DVD video standard. Moreover, although not shown in FIG. 7, in the writable optical disk, an R-Information Area used for various processing steps required for data writing is provided.

The DVD-Video zone stores a VMG (Video Manager) and a plurality of VTSs (Video Title Sets). Each VTS includes VTSI (Video Title Set Information), VTSM_VOBS (Video Title Set Menu Video Objects), VOBS (Video Objects) and VTSI_BUP (Video Title Set Information Backup). VTSM_VOBS is contents for a title selection menu and stores pictures for displaying a title menu and the like. VTSI_BUP stores backup information for VTSI.

VOBS include one or more VOBs (Video Objects). VOB is part of a program stream of MPEG, including a plurality of elementary streams of MPEG, and includes one or more (maximum 255) CELLs. CELL is the smallest addressable unit and also a unit of contents to be reproduced. Moreover, each CELL includes a recognizable, unique ID. VOBU is the smallest playback unit according to the DVD video standard. Each VOBU includes a single NV_PCK, an arbitrary number of video packs (V_PCK) and an arbitrary number of audio packs (A_PCK). V_PCK stores video data. A_PCK stores audio data.

NV_PCK includes PCI_PKT (Program Chain Information Packet) and DSI_PKT (Data Search Information Packet). PCI_PKT stores playback control information of VOBU to which it belongs. DSI_PKT stores VOB_V_S_PTM and VOB_V_E_PTM as seamless playback information and BWDI and FWDI as VOBU search information (VOBU_SRI). VOB_V_S_PTM is reproduction start time information of a head video frame of a head GOP (Group of Picture) in VOB. VOB_V_E_PTM is reproduction end time information of a final video frame of a final GOP in VOB. BWDI is 4-byte information indicating a relative address between VOBUs used in rewinding of data and FWDI is 4-byte information indicating a relative address between VOBUs used in fast forwarding of data.

In the DVD video standard, NV_PCK located in a head of each VOBU can not be created until which VOB the VOBU belongs to is determined. This is because the DVD video standard is originally an authoring standard and does not target at recording of data in real time. Thus, the DVD video standard is not suitable for recording of stream data requiring real time characteristics.

In general, when data is written on an optical disk, as initial preparation in an optical drive, write power optimization (which will be also referred to as “OPC: Optimum Power Calibration”) and data write learning are performed.

Conventionally, a technique in which a buffer having a sufficiently large size for storing stream data corresponding to a learning time of various kinds in writing data to an optical drive is provided to record stream data on an optical disk in real time, according to the DVD video standard has been proposed.

FIG. 8 is a graph showing the relationship between transition of an accumulated data amount of a buffer and initial preparation. In a period from a start of recording of stream data to a start of creation of NV_PCK in a first VOBU, stream data (BUFF_FORMAT) corresponding to a single VOB is accumulated in a buffer. When NV_PCK of VOBU is created, valid data (VOB) is finally completed and OPC is generated in an optical drive. Thereafter, when a write-in start request for the data (VOB) is issued to the optical drive, data write learning is generated in the optical drive. During the initial preparation, video/audio data is continuously received, stream data having a data size (BUFF_OPC) corresponding to a time required for OPC and stream data having a data size (BUFF_ADJ) corresponding to a time required for data write learning are accumulated in the buffer.

Although not shown in FIG. 8, when a temperature in the optical drive exceeds a certain range while data is written on an optical disk, temperature learning in the optical drive is generated and parameters such as laser power and the like are changed. Even during temperature learning, vide/audio data is continuously received and thus stream data having a data size (BUFF_TEMP) corresponding to a time required for temperature learning is accumulated in the buffer. Accordingly, in the known recording apparatus, a buffer having a size corresponding to at least the total of BUFF_FORMAT, BUFF_OPC, BUFF_ADJ and BUFF_TEMP has to be provided. That is, a relatively large buffer is needed and costs are increased. Therefore, the above-described method and apparatus are not preferable.

### SUMMARY OF THE INVENTION

In view of the above-described problems, the present invention is directed to a stream data recording apparatus and aims to realize recording of stream data obtained by compression coding video/audio data on an optical recording medium in real time with a smaller buffer size.

To solve the above-described problems, means which has been devised according to the present invention, as a method for recording stream data obtained by compression coding video/audio data on an optical recording medium in real time, includes: a first step of receiving the video/audio data and generating from the video/audio data a data object complying with a standard with respect to the recording; a second step of performing initial preparation for data writing to the optical recording medium; and a third step of writing, subsequently to the second step, the generated data object in the first step to the optical recording medium. In the inventive method, the second step is executed during execution of the first step. Moreover, as an apparatus for recording stream data obtained by compression coding video/audio data on an optical recording medium in real time, another means devised according to the present invention includes: a data object generation section for receiving the video/audio data and generating from the video/audio data a data object complying with a standard with respect to the recording; a buffer for temporarily accumulating the generated data object generated by the data object generation section; and an optical recording section for writing the accumulated data object in the buffer to the optical recording medium. In the inventive apparatus, the optical recording section performs initial preparation for data writing to the optical recording medium during generation of the data object by the data object generation section.

Thus, the data object complying with the standard is generated from the received video/audio data and the initial preparation for data writing to the optical recording medium during the generation of the data object. Subsequently, the generated data object is written to the optical recording medium. Therefore, a buffer for accumulating stream data having a data size corresponding to a time required for the initial preparation does not have to be specially provided and stream data obtained by compression coding video/audio data can be recorded on the optical recording medium in real time with a smaller buffer size.

Specifically, the optical recording medium includes a plurality of recording layers and, when a destination to which the data object is written is switched from one recording layer to another recording layer in the optical recording medium, the second step is executed. That is, the optical recording medium includes a plurality of recording layers and the optical recording section performs the initial preparation when the optical recording section switches a destination to which the data object is written from one recording layer to another recording layer in the optical recording medium. Thus, even when the optical recording medium includes a plurality of recording layers, stream data obtained by compression coding video/audio data can be recorded on the optical recording medium in real time with a smaller buffer size.

More specifically, in the initial preparation, write power optimization for data writing to the optical recording medium is performed. That is, as the initial preparation, the optical recording section performs write power optimization for data writing to the optical recording medium. Thus, a buffer for accumulating stream data having a data size corresponding to a time required for write power optimization for data writing to the optical recording medium in the initial preparation does not have to be specially provided and stream data obtained by compression coding video/audio data can be recorded on the optical recording medium in real time with a smaller buffer.

More specifically, in the initial preparation, recording management information is written in a predetermined region of the optical recording medium or, as dummy data, a still image contained in the stream data and the like is written in a predetermined region of the optical recording medium. That is, as the initial preparation, the optical recording section writes recording management information in a predetermined region of the optical recording medium or writes dummy data in a predetermined region of the optical recording medium. Thus, a buffer for accumulating stream data having a data size corresponding to a time required for writing recording management information or dummy data to the optical recording medium (or data write learning) in the initial preparation does not have to be specially provided and stream data obtained by compression coding video/audio data can be recorded on the optical recording medium in real time with a smaller buffer.

More specifically, when the optical recording medium includes a plurality of recording layers, in the initial preparation, information for a defective track in one recording layer is written in a predetermined region of the optical recording medium or information for a recovery from a power failure or the like is written in a predetermined region of another recording layer. That is, as the initial preparation when the optical recording medium includes a plurality of recording layers, the optical recording section writes such information in a predetermined region of one recording layer or another recording layer of the optical recording medium.

Preferably, the generation of the data object in the first step is completed before completion of the initial preparation in the second step. Specifically, a data size of the data object generated by the data object generation section is a data size at largest with which the generation of the data object is completed before completion of the initial preparation by the optical recording section. Thus, immediately after completion of the initial preparation, writing of the data object on the optical recording medium can be started, so that a data size of stream data to be accumulated can be minimized.

Specifically, a time required for generating the data object in the first step is changed according to any one or a combination of a recording rate of the stream data, a speed and a standard of the optical recording medium and the number of frames included in a video object unit as a minimum reproduction unit complying with the standard with respect to the recording. That is, the data object generation section changes the data size of the data object of the above-described conditions. Thus, an optimum time for generating the data object can be set according to any one or a combination of a recording rate of the stream data, the speed and the standard of the optical recording medium and the number of frames included in a video object unit.

Preferably, in the third step, the data object is written on the optical recording medium by performing a write operation for a plurality of times. That is, the optical recording section writes the data object on the optical recording device by performing a write operation for a plurality of times. Thus, a generation timing of temperature learning in the optical drive can be shifted from a timing at which the accumulated data amount of stream data becomes a maximum. Therefore, a buffer for accumulating stream data having a data size corresponding to a time required for temperature learning in the optical drive does not have to be specially provided and stream data obtained by compression coding video/audio data can be recorded on the optical recording medium in real time with a smaller buffer size.

Specifically, in the third step, the data object is written on the optical recording medium by performing a write operation twice, and a size of data written by a second write operation is smaller than a size of data written by a first write operation. That is, the optical recording section writes the data object by two separate write operations and the size of data to be written by the second write operation is smaller than the size of data to be written by the first write operation.

More specifically, in the third step, the data object is divided into a plurality of data blocks having substantially equal data sizes and is written on the optical recording medium. That is, the optical recording section divides the data object into a plurality of data blocks having substantially equal data sizes and writes the divided data objects to the optical recording medium. Thus, the size of data to be written by a single write operation can be restricted, so that a time interval of data writing can be reduced. Accordingly, temperature change can be reduced and the generation of temperature learning in the optical drive can be suppressed.

### BRIEF DESCRIPTION OF THE DRAWINGS

FIG. 1 is a block diagram illustrating a configuration of a stream data recording apparatus according to the present invention.

FIG. 2 is a diagram illustrating an exemplary temporal sequence of processing by the recording apparatus of FIG. 1.

FIG. 3 is a graph showing transition of an accumulated data amount of a buffer with respect to the processing temporal sequence of FIG. 2.

FIG. 4 is a graph showing transition of an accumulated data amount of a buffer with respect to the processing temporal sequence of FIG. 2.

FIG. 5 is a diagram illustrating another exemplary temporal sequence of processing by the recording apparatus of FIG. 1.

FIG. 6 is a graph showing transition of an accumulated data amount of a buffer with respect to the processing temporal sequence of FIG. 5.

FIG. 7 is a diagram illustrating a data structure complying with the DVD video standard.

FIG. 8 is a graph showing transition of an accumulated data amount of a buffer in a known recording apparatus.

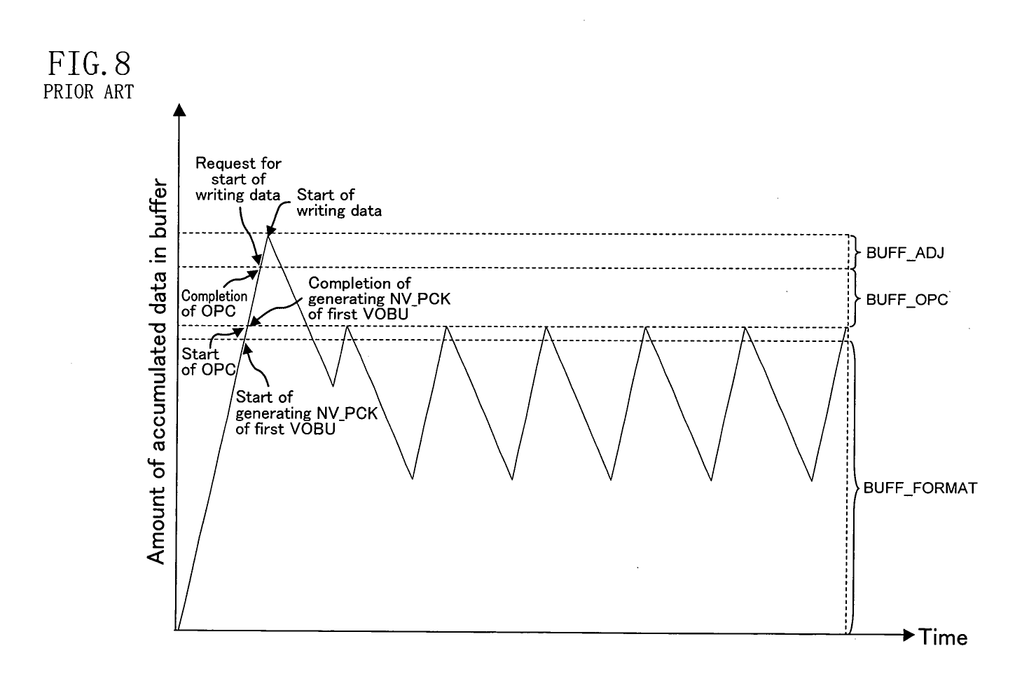

### BEST MODE FOR CARRYING OUT THE INVENTION

Hereafter, best modes of the present invention will be described with reference to the accompanying drawings.

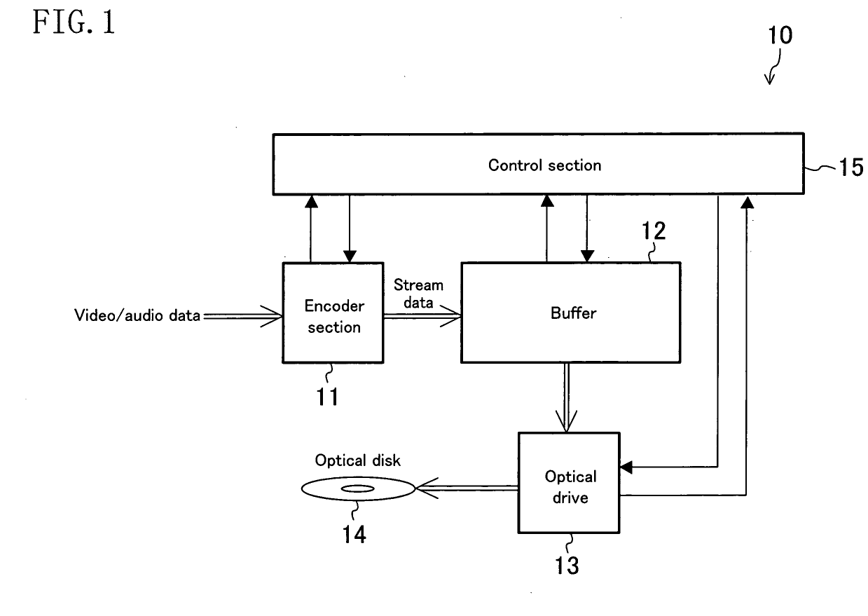

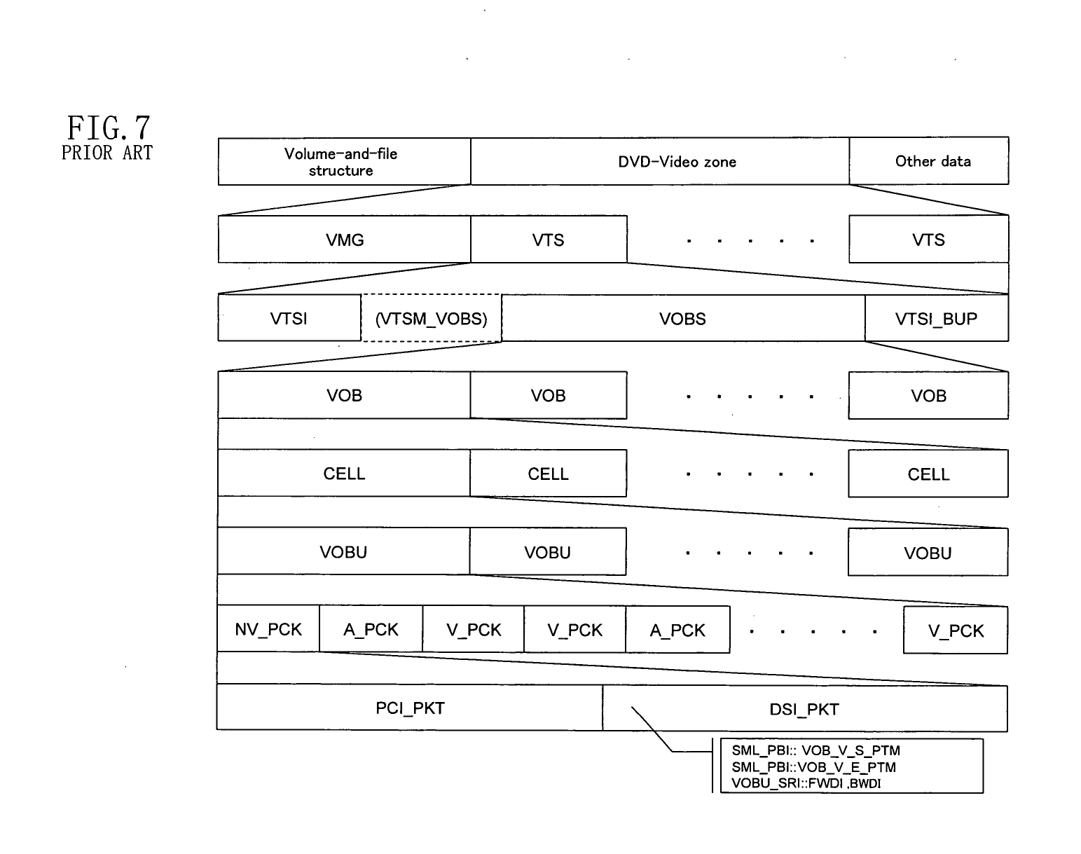

FIG. 1 is a block diagram illustrating a configuration of a stream data recording apparatus (which will be also referred to as merely a “recording apparatus”) according to the present invention. The recording apparatus 10 includes an encoder section 11, a buffer 12, an optical drive 13 and a control section 15. The recording apparatus 10 is, for example, a DVD recorder, a Bluray recorder, a HD-DVD recorder, a DVD camcorder, a HDD recorder or HDD camcorder to which an optical drive is connected, or the like. Hereafter, for simplification of description, the recording apparatus 10 records stream data in an optical disk 14 according to the DVD video standard (see FIG. 7). For example, the optical disk 14 is an optical recording disk such as a DVD-R and the like. Each VOB includes a signal CELL.

The encoder section 11 compression codes received video/audio data to generate stream data complying with the DVD video standard. Specifically, the encoder section 11 properly converts received video/audio data to generate V_PCK, A_PCK and NV_PCK included in VOBU and accumulates V_PCK, A_PCK and NV_PCK in the buffer 12. Since DSI_PKT contains information which can not be decided until stream data corresponding to a single VOB is accumulated, a data size is ensured for undecided information by substituting “0” data or the like. Moreover, the encoder section 11 functions as a data object generation section. Specifically, when VOBU corresponding to a single VOB managed in terms of time or size is accumulated in the buffer 12, the encoder section 11 generates DSI_PKT of each VOBU and overwrites the data on NV_PCK located in a head of each VOBU accumulated in the buffer 12. Thus, a valid data object (VOB) which is writable to the optical disk 14 is finally completed.

The optical drive 13 takes out data (VOB) from the buffer 12 and writes the data on the optical disk 14. The control section 15 controls respective operation timings of the encoder section 11, the buffer 12 and the optical drive 13.

The optical drive 13 performs initial preparation such as write power optimization (OPC), recording management information setting and data write learning while the encoder section 11 generates a first VOB. Specifically, write power optimization (OPC) is performed by irradiating laser light to an R-Information Area of optical disk 14, and more specifically, a power calibration area (PCA). Moreover, recording management information setting is performed by writing recording management information in the R-Information Area of the optical disk 14, and more specifically, in a recording management information area (RMA). Data write learning is performed by recording dummy data in a boundary part between VOBS and VTSI or around the boundary shown in FIG. 7. Moreover, when a temperature in the optical drive 13 is increased to a level exceeding a certain range during data writing, the optical drive 13 performs temperature learning to change a parameter such as laser power and the like.

When stream data is video data complying with the MPEG standard, I pictures contained in the stream data are written as dummy data in write learning. Assume the case where the optical disk 14 includes a plurality of recording layers. When a data writing destination is switched from a first recording layer (which will be hereafter referred to as a “first layer”) to another recording layer (which will be hereafter referred to as a “second layer), in data write learning with respect to the second layer, defective track information in a layer (first layer) in which data is recorded may be written in a predetermined region of the second layer. The defective track information may be written in a predetermined region of the first layer. By writing the dummy data in a predetermined region, the I pictures written as the dummy data can be used for finishing process for the optical disk 14. Moreover, defective track information can be used as information for avoiding defective part of the second layer when data (VOB) is recorded in the second layer of the optical disk 14.

Moreover, when the optical disk 14 includes a plurality of recording layers and the data writing destination is switched from the first layer to the second layer, information for a recovery from a power failure may be written in a predetermined region of the second layer. Normally, VTSI can not be written until a writing operation of necessary VOB is completed. Thus, stream management information including necessary information for VTSI recovery, information indicating to which part data writing is completed and the like is regularly recorded in another storage means. When data writing is completed, the stream management information is read out from the storage means and written in the optical disk 14. There might be a case where during the switching operation between the recording layers of the optical disk 14, access to the storage means is limited and the stream management information is not updated. In such a case, if data writing is abnormally ended during data writing into the second layer due to a power failure or the like, only part indicated by the stream management information stored in the storage means, i.e., data in part of the first layer can be recovered. To cope with this, as described above, at a time of a switching of the data writing destination when access to the storage means is limited, the stream management information is written as information for the recovery from the power failure in a predetermined region of the second layer. Thus, in recognition processing of the optical disk 14 after the recovery from the power failure, based on the stream management information recorded in the predetermined region of the second layer, at least data written in the first layer can be all recovered.

The recording apparatus 10 may be so configured that the encoder section 11 and the control section 15 function as a data object generation section. In this case, when VOBUs corresponding to a single VOB are accumulated in the buffer 12, the encoder section 11 may issue a request for generating DSI_PKT and, in response to the request, the control section 15 may generate DSI_PKT.

Next, some of operation examples of the recording apparatus 10 will be described.

### First Operation Example

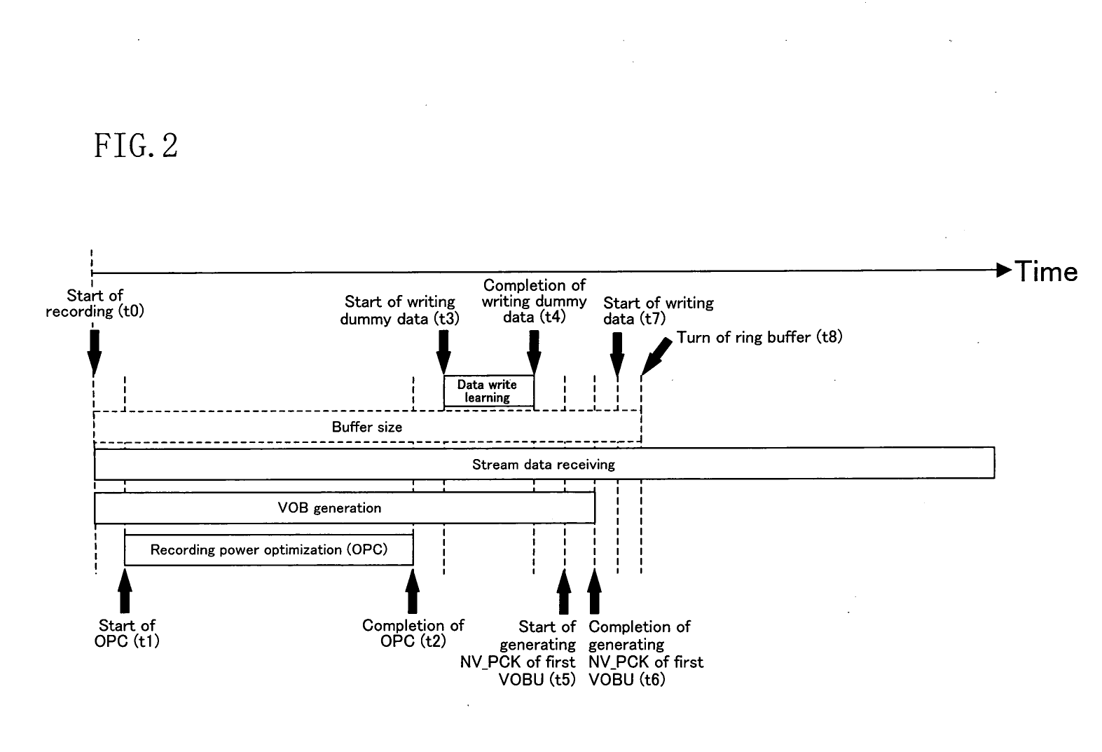

FIG. 2 is a diagram illustrating an exemplary temporal sequence of processing by the recording apparatus 10. At the same time as a start of recording stream data, VOB generation is started (t0). As described above, video/audio data for a single VOB is not received, valid VOB can not be generated. Subsequently, during the VOB generation, recording power optimization (OPC) is started in the optical drive 13 (t1). When OPC is completed (t2), dummy data writing to the optical disk 14 is started (t3) and data write learning in the optical drive 13 is performed. When the dummy data writing is ended (t4), initial preparation of the optical drive 13 is completed.

In the VOB generation performed in parallel to the initial preparation, when necessary video/audio data for generating a first VOB is received, creation of NV_PCK of the first VOBU is started (t5). When the creation of the NV_PCK of the first VOBU is completed (t6), data writing to the optical disk 14 is finally started (t7). Specifically, DSI_PKT is generated and the generated data is overwritten on VOBU accumulated in the buffer 12, so that the creation of NV_PCK is completed. A buffer size indicated by a broken line in FIG. 2 denotes a volume of the buffer 12 to be ensured in this operation example. Moreover, when an end of the buffer 12 is reached, a ring buffer makes a turn (t8).

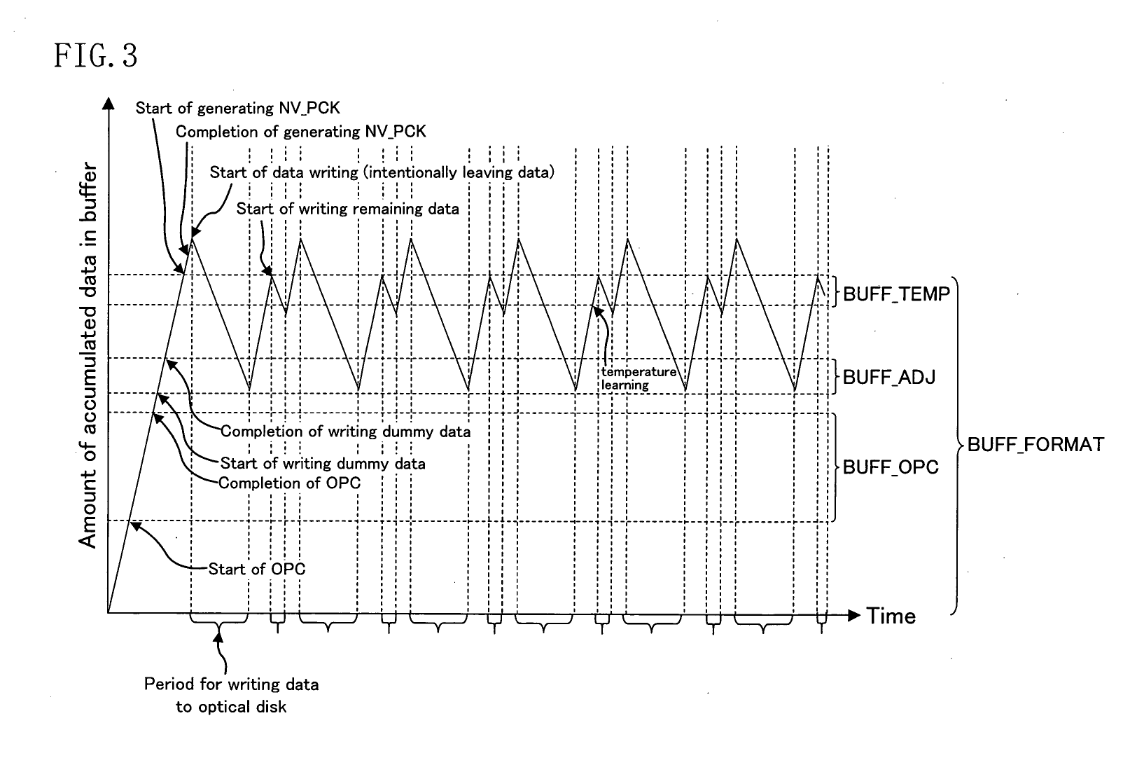

FIG. 3 is a graph showing the relationship between transition of an accumulated data amount of the buffer 12 in the processing temporal sequence of FIG. 2 and initial preparation in the optical drive 13. In FIG. 3, the ordinate denotes the accumulated data amount of the buffer 12 and the abscissa denotes time. When recording of stream data is started, the accumulated data amount of the buffer 12 is increased. In the optical drive 13, OPC and dummy data writing are performed before NV_PCK is created in a first VOBU. When video/audio data necessary for creating a first VOB is received, finally, NV_PCKs in VOBUs are sequentially created and the first VOB is determined. The accumulated data in the buffer 12 is turned to a writable state by VOB being determined and written on the optical disk 14.

When data writing to the optical disk 14 is started, the accumulation data amount of the buffer 12 is started to be reduced. In this operation example, at a time when the first writable VOB is generated, the initial preparation in the optical drive 13 is completed. Therefore, a buffer for accumulating stream data having a data size (BUFF_OPC, BUFF_ADJ) corresponding to a time required for the initial preparation does not have to be specially provided.

Preferably, data (VOB) which has been turned to a writable state is written to the optical disk 14 by two separated writing operations. Thus, a generation timing of temperature learning in the optical drive 13 can be shifted from a timing at which the accumulated data amount of the buffer 12 reaches a peak. Therefore, a buffer for accumulating stream data having a data size (BUFF_TEMP) corresponding to a time required for the temperature learning does not have to be specially provided.

More preferably, data in head part of VOB is written by first data writing so that data in last part of VOB is left, and the remaining data is written by second data writing before a start of data writing of next VOB. Thus, the temperature in the optical drive 13 is sufficiently increased by the first data writing, so that temperature learning is readily generated between the first and second data writings. Therefore, a start timing of data writing of the next VOB is not influenced.

As has been described, according to this operation example, buffers for accumulating stream data having a data size (BUFF_OPC, BUFF_ADJ) corresponding to a time required for initial preparation in the optical drive 13 and stream data having a data size (BUFF_TEMP) corresponding to a time required for the temperature learning in the optical drive 13 do not have to be specially provided. Therefore, stream data obtained by compression coding video/audio data can be recorded on an optical medium in real time with a smaller buffer size.

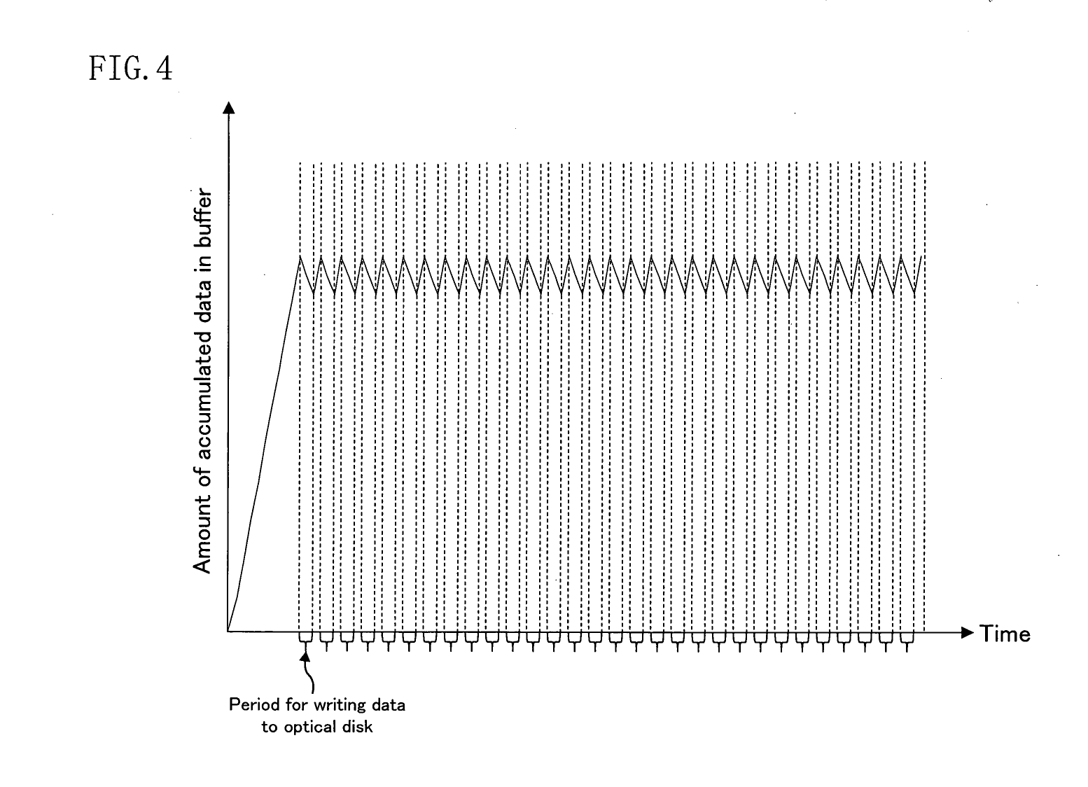

As shown in FIG. 4, the optical drive 13 may divide data (VOB) which has been turned to a writable state into pieces having substantially equal data sizes and write the divided data on the optical disk 14. Moreover, the optical drive 13 may divide data (VOB) which has been turned to a writable state according to the number of VOBUs and write the divided data to the optical disk 14 by a plurality of writing operations. Thus, rapid temperature change in the optical drive 13 can be suppressed and temperature learning is less generated.

Moreover, a start of creating NV_PCK can be executed as long as video/audio data for a single VOB is received. Therefore, creating NV_PCK may be performed even during data write learning. In this case, after data learning is completed, data (VOB) which has been turned to a writable state can be written on the optical disk 14.

### Second Operation Example

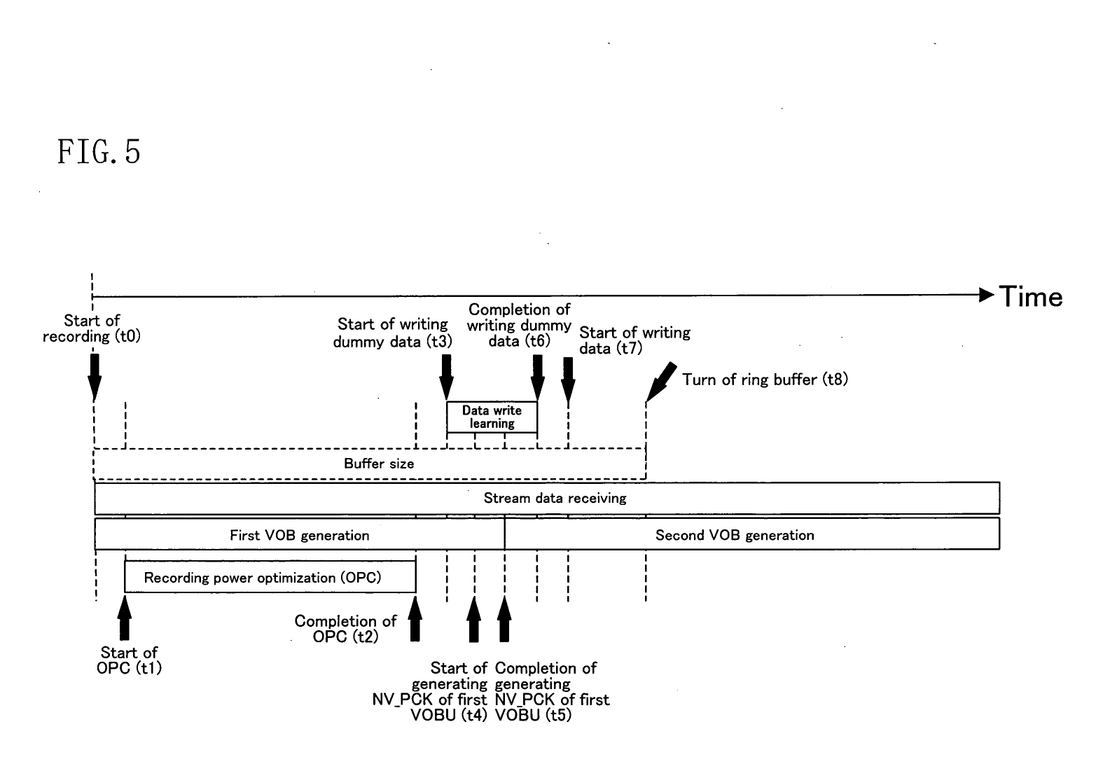

FIG. 5 is a diagram illustrating another exemplary temporal sequence of processing by the recording apparatus 10. At the same time as a start of recording stream data, first VOB generation is started (t0). Subsequently, during the process of generating the first VOB, recording power optimization (OPC) is started in the optical drive 13 (t1). When OPC is completed (t2), writing of dummy data to the optical disk 14 is started (t3) and write learning in the optical drive 13 is performed.

When receiving of video/audio data necessary for generating a first VOB is completed, creation of the NV_PCK of the first VOBU is started (t4). The creation of NV_PCK of the first VOBU is completed (t5) before the writing of the dummy data is completed (t6). After completion of the dummy data writing, writing of data (VOB) to the optical disk 14 is started (t7). A buffer size indicated by a broken line in FIG. 5 denotes a volume of the buffer 12 to be ensured in this operation example. Moreover, when an end of the buffer 12 is reached, a ring buffer makes a turn (t8).

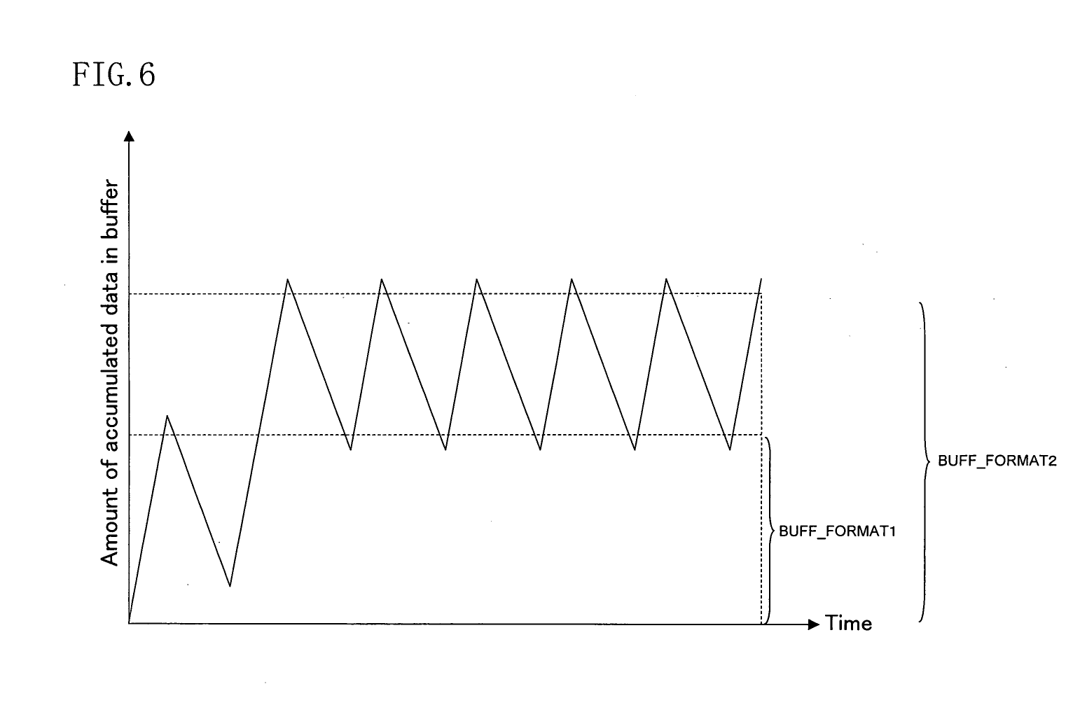

FIG. 6 is a graph showing transition of an accumulated data amount of the buffer 12 in the processing temporal sequence of FIG. 5. As shown in FIG. 6, because the first VOB has to have a data size with which the VOB generation is completed before initial preparation in the optical drive 13 is completed, a data size (BUFF_FORMAT1) necessary for generating the first VOB is smaller than a data size (BUFF_FORMAT2) necessary for generating second or later VOB. An optimal size can be set by setting the data size of the first VOB according to a recording rate. The recording rate is determined by a recording mode determined by the time of recording start, for example, an XP mode (recording time on one side: about 1 hour), an SP mode (recording time on one side: 2 hours) and the like and complicity of video data to be received.

The data size of the first VOB may be set according to not only the recording rate of stream data but also any one or a combination of writing a speed and a standard of the optical disk 14, the number of frames contained in VOBU.

Moreover, needless to say, if data which has been turned to a writable is recorded on the optical disk 14 by a plurality of writing operations in the same manner as the first operation example, a buffer for accumulating stream data having a data size (BUFF_TEMP) corresponding to a time required for temperature learning in the optical drive 13 does not have to be specially provided.

As has been described, according to this operation example, NV_PCK of the first VOBU is created in a period before completion of initial preparation in the optical drive 13. Thus, writing of data (VOB) can be started immediate after completion of initial preparation in the optical drive 13 and a data size of stream data to be accumulated can be suppressed to a minimum. Moreover, with a buffer size ensured for accumulating stream data necessary for generating second or later VOB, video/audio data received during a time required for initial preparation of the optical drive 13 can be accumulated, a buffer for accumulating stream data having a data size (BUFF_OPC, BUFF_ADJ) corresponding to a time required for initial preparation of the optical drive 13 does not have to be specially provided and thus with a smaller buffer size, stream data obtained by compression coding video/audio data can be recorded on an optical medium in real time.

In the first and second operation examples, assume the case where the optical disk 14 includes a plurality of recording layers. In that case, when a writing destination for data (VOB) is switched from the first layer to the second layer, initial preparation in the optical drive 13 may be performed.

In the second operation example, a necessary data size (BUFF_FORMAT2) for generating second or later VOB does not have to be constant.

If the generation of the first VOB is completed during recording power optimization (OPC) in the optical drive 13, a data writing request is issued to the optical drive 13 at a time when the creation of NV_PCK may be completed and data write learning may be performed using data (VOB) which has been turned to a writable state, instead of dummy data.

The description above is given with respect to the DVD video standard. However, the present invention is applicable to some other standard and recording medium, for example, a Bluray disk.

What is claimed is:

1. A method for recording stream data obtained by compression coding video/audio data on an optical recording medium in real time, the method comprising:
a first step of receiving the video/audio data and generating from the video/audio data a data object complying with a standard with respect to the recording;
a second step of performing initial preparation for data writing to the optical recording medium; and
a third step of writing, subsequently to the second step, the generated data object in the first step to the optical recording medium;
wherein the second step is executed during execution of the first step.

2. The method of claim 1, wherein the optical recording medium includes a plurality of recording layers, and
when a destination to which the data object is written is switched from one recording layer to another recording layer in the optical recording medium, the second step is executed.

3. The method of claim 2, wherein in the initial preparation, write power optimization for data writing to the optical recording medium is performed.

4. The method of claim 2, wherein in the initial preparation, recording management information is written in a predetermined region of the optical recording medium.

5. The method of clam 2, wherein in the initial preparation, dummy data is written in a predetermined region of the optical recording medium.

6. The method of claim 5, wherein the dummy data is a still image contained in the stream data.

7. The method of claim 2, wherein in the initial preparation, information for a defective track in said one recording layer is written in a predetermined region of the optical recording medium.

8. The method of claim 2, wherein in the initial preparation, information for a recovery from a power failure is written in a predetermined region of said another recording layer.

9. The method of claim 2, wherein the generation of the data object in the first step is completed before completion of the initial preparation in the second step.

10. The method of claim 9, wherein a time required for generating the data object in the first step is changed according to any one or a combination of a recording rate of the stream data, a speed and a standard of the optical recording medium and the number of frames included in a video object unit as a minimum reproduction unit complying with the standard with respect to the recording.

11. The method of claim 1, wherein in the initial preparation, write power optimization for data writing to the optical recording medium is performed.

12. The method of claim 1, wherein in the initial preparation, recording management information is written in a predetermined region of the optical recording medium.

13. The method of claim 1, wherein in the initial preparation, dummy data is written in a predetermined region of the optical recording medium.

14. The method of claim 13, wherein the dummy data is a still image contained in the stream data.

15. The method of claim 1, wherein generation of the data object in the first step is completed before completion of the initial preparation in the second step.

16. The method of claim 15, wherein a time required for generating the data object in the first step is changed according to any one or a combination of a recording rate of the stream data, a speed and a standard of the optical recording medium and the number of frames included in a video object unit as a minimum reproduction unit complying with the standard with respect to the recording.

17. The method of claim 1, wherein in the third step, the data object is written to the optical recording medium by performing a write operation for a plurality of times.

18. The method of claim 17, wherein in the third step, the data object is written to the optical recording medium by performing a write operation twice, and
a data size of data written by a second write operation is smaller than a data size of data written by a first write operation.

19. The method of claim 17, wherein in the third step, the data object is divided into a plurality of data blocks having substantially equal data sizes and is written to the optical recording medium.

20. An apparatus for recording stream data obtained by compression coding video/audio data in real time, the apparatus comprising:
a data object generation section for receiving the video/audio data and generating from the video/audio data a data object complying with a standard with respect to the recording;
a buffer for temporarily accumulating the generated data object generated by the data object generation section; and
an optical recording section for writing the accumulated data object in the buffer to the optical recording medium,
wherein the optical recording section performs initial preparation for data writing to the optical recording medium during generation of the data object by the data object generation section.

21. The apparatus of claim 20, wherein the optical recording medium includes a plurality of recording layers, and
the optical recording section performs the initial preparation when the optical recording section switches a destination to which the data object is written from one recording layer to another recording layer in the optical recording medium.

22. The apparatus of claim 21, wherein as the initial preparation, the optical recording section performs write power optimization for data writing to the optical recording medium.

23. The apparatus of claim 21, wherein as the initial preparation, the optical recording section writes recording management information in a predetermined region of the optical recording medium.

24. The apparatus of claim 21, wherein as the initial preparation, the optical recording section writes dummy data in a predetermined region of the optical recording medium.

25. The apparatus of claim 24, wherein the dummy data is a still image contained in the stream data.

26. The apparatus of claim 21, wherein as the initial preparation, the optical recording section writes information for a defective track in said one recording layer in a predetermined region of the optical recording medium.

27. The apparatus of claim 21, wherein as the initial preparation, the optical recording section writes information for a recovery from a power failure in a predetermined region of said another recording layer.

28. The apparatus of claim 21, wherein a data size of the data object generated by the data object generation section is a data size at largest with which the generation of the data object is completed before completion of the initial preparation by the optical recording section.

29. The apparatus of claim 28, wherein the data object generation section changes the data size of the data object according to any one or a combination of a recording rate of the stream data, a speed and a standard of the optical recording medium and the number of frames included in a video object unit as a minimum reproduction unit complying with the standard with respect to the recording.

30. The apparatus of claim 20, wherein as the initial preparation, the optical recording section performs write power optimization for data writing to the optical recording medium.

31. The apparatus of claim 20, wherein as the initial preparation, the optical recording section writes recording management information in a predetermined region of the optical recording medium.

32. The apparatus of claim 20, wherein as the initial preparation, the optical recording section writes dummy data in a predetermined region of the optical recording medium.

33. The apparatus of claim 32, wherein the dummy data is a still image contained in the stream data.

34. The apparatus of claim 20, wherein a data size of the data object generated by the data object generation section is a data size at largest with which the generation of the data object is completed before completion of the initial preparation by the optical recording section.

35. The apparatus of claim 34, wherein the data object generation section changes the data size of the data object according to any one or a combination of a recording rate of the stream data, a speed and a standard of the optical recording medium and the number of frames included in a video object unit as a minimum reproduction unit complying with the standard with respect to the recording.

36. The apparatus of claim 20, wherein the optical recording section writes the data object to the optical recording medium by performing a write operation for a plurality of times.

37. The apparatus of claim 36, wherein the optical recording section writes the data object to the optical recording medium by performing a write operation twice, and a data size of data written by a second write operation is smaller than a data size of data written by a first write operation.

38. The apparatus of claim 36, wherein the optical recording section divides the data object into a plurality of data blocks having substantially equal data sizes and writes the divided data objects to the optical recording medium.
